(19) United States
(12) Patent Application Publication
(10) Pub. No.: US 2002/0083147 A1
(43) Pub. Date: Jun. 27, 2002

(54) System and method for on line real time transmitting a motion picture to a user system

(76) Inventor: Kurt G. Ripperger, Tucson, AZ (US)

Correspondence Address: Lawrence R. Oremland, Lawrence R. Oremland, P.C., Suite C-214, 5055 East Broadway Boulevard, Tucson, AZ, 85711, US

(21) Appl. No.: 10/003,895

(22) Filed: Oct. 25, 2001

Related U.S. Application Data
(60) Provisional application No. 60/306,002, filed on Oct. 31, 2000.

(51) Int. Cl. G06F 15/167

(52) U.S. Cl. 709/213

(57) ABSTRACT

A method and system for testing the downloading speed of a user system, on line and in real time, as a motion picture transmission system prepares to transmit a motion picture file. The transmission of the motion picture file, e.g. as a banner file, a message file, or some other file including a motion picture, can then be in a file format and/or file size which is most compatible with the downloading speed capabilities of the user system. A test device is configured to test the downloading speed of the user system, on line and in real time as the system prepares to transmit the motion picture file. The system is configured to send the motion picture file in one format if the downloading speed of the user system is at or slower than a predetermined speed and in another format if the downloading speed of the user system is faster than the predetermined speed. In addition, the system and method of the invention can be configured such that the motion picture file is transmitted in the predetermined format and preferably in a file size which is most compatible with the downloading speed of the user system.

### RELATED APPLICATION/CLAIM OF THE PRIORITY

This application is related to and claims from Provisional Application Serial No. 60/306,002, filed Oct. 31, 2000.

### TECHNICAL FIELD

The present invention relates to a system for on line, real time testing the downloading speed of a user system and transmitting an image file (e.g. a motion picture file) to the user system, in a file format and/or file size that is appropriate for the user system.

### INTRODUCTION

Applicant believes that when transmitting an image file (e.g. a motion picture file) on line to an end user system (e.g. across the internet, across some other form of packet switched system, by means of a wireless transmission, etc.), it is desirable to test the downloading speed of the end user system, on line and in real time, as the system prepares to transmit the image file. The transmission of the image file, e.g. as a banner file, a message file, or some other file including an image file, can then be transmitted in a file format and/or file size which is most compatible with the downloading speed capabilities of the end user system. As used herein, the term “image file” means a still image file (e.g. in gif, jpeg, tif format, etc.), a motion picture file (which may or may not include an audio portion) or a combination of the foregoing.

In a system for transmitting an image file to an end user system, according to one aspect of the present invention, a test device is configured to test the downloading speed of the end user system, on line and in real time, as the transmitting system prepares to transmit the image file. The transmitting system is configured to send the image file in one format if the downloading speed of the end user system is at or slower than a predetermined speed and in another format if the downloading speed of the end user system is faster than the predetermined speed.

In transmitting an image file on line to an end user system, according to another aspect of the present invention, the end user system is tested, in real time and on line, to determine if the end user system can play an image file (e.g. a motion picture file) in a predetermined file format. If it cannot, the image file is sent in an alternative format. If it can, the downloading speed of the end user system is tested, in real time and on line, and if the end user system has a minimum predetermined downloading speed and can play the image file in the predetermined format the image file is transmitted in the predetermined format and preferably in a file size which is most compatible with the downloading speed of the end user system.

In its preferred form, the system of the invention is “seamless” in the sense that it tests the downloading speed capabilities of the end user system, and sends the image file in a format that is appropriate for the downloading speed capabilities of the end user system in a manner that is essentially invisible to the end user system.

Further features of the present invention will be apparent from the following detailed description and the accompanying drawings.

### BRIEF DESCRIPTION OF THE DRAWINGS

FIG. 1 is a schematic illustration of a system for testing and transmitting a motion picture file to an end user system, on line and in real time, according to the principles of the present invention;

FIG. 2 is a flow chart illustrating the manner in which a message file is transmitted to an end user system, according to the principles of the present invention; and

FIG. 3 is a flow chart illustrating the manner in which a banner file is transmitted to an end user system, according to the principles of the present invention.

### DETAILED DESCRIPTION

As described above, the present invention provides a system and method for testing and transmitting an image file (e.g. a motion picture file) to an end user system, on line and in real time. The principles of the invention are described below in connection with the transmission of a motion picture file and a banner, but it will be clear to those in the art that the principles of the present invention can be used with various types of image files.

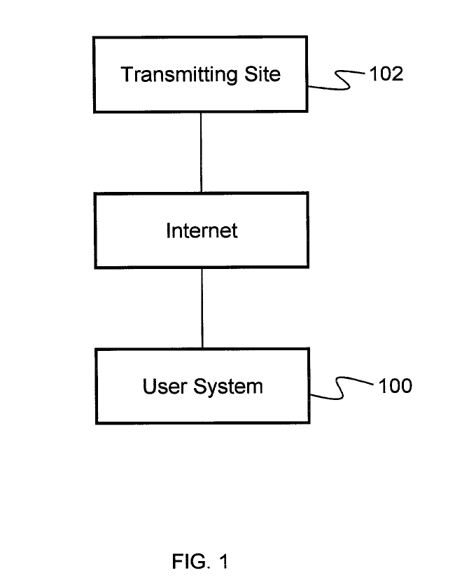

As schematically illustrated in FIG. 1, an end user system 100 is in communication (e.g. across the internet) with a transmission device 102 configured to transmit a motion picture file to the user system. The transmission device 102 can be, e.g., a device configured that when requested by an end user system or by a device such as a web site seeking to transmit a motion picture file to an end user system, can test the downloading speed (and other characteristics) of the end user system, and then transmit a motion picture file to the end user system in a manner most compatible with the capabilities of the end user system. The present invention provides one or more software modules, which form the transmission device 102, and function to test certain capabilities of the end user system, on line and in real time, and then transmit the motion picture file in a manner determined by such testing.

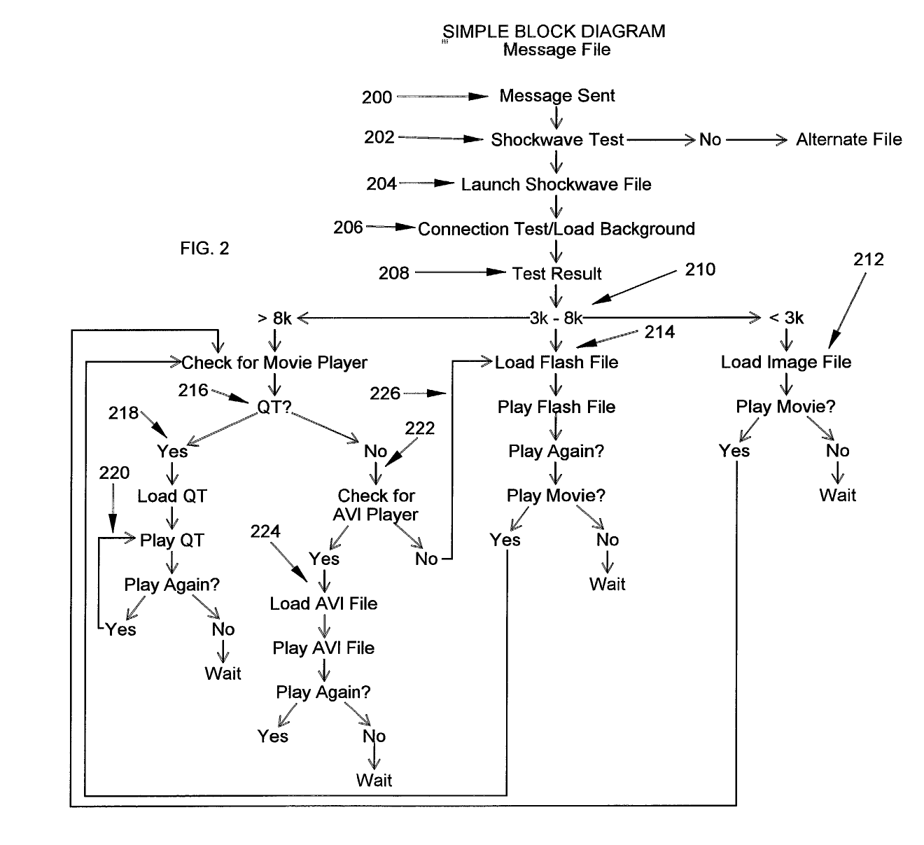

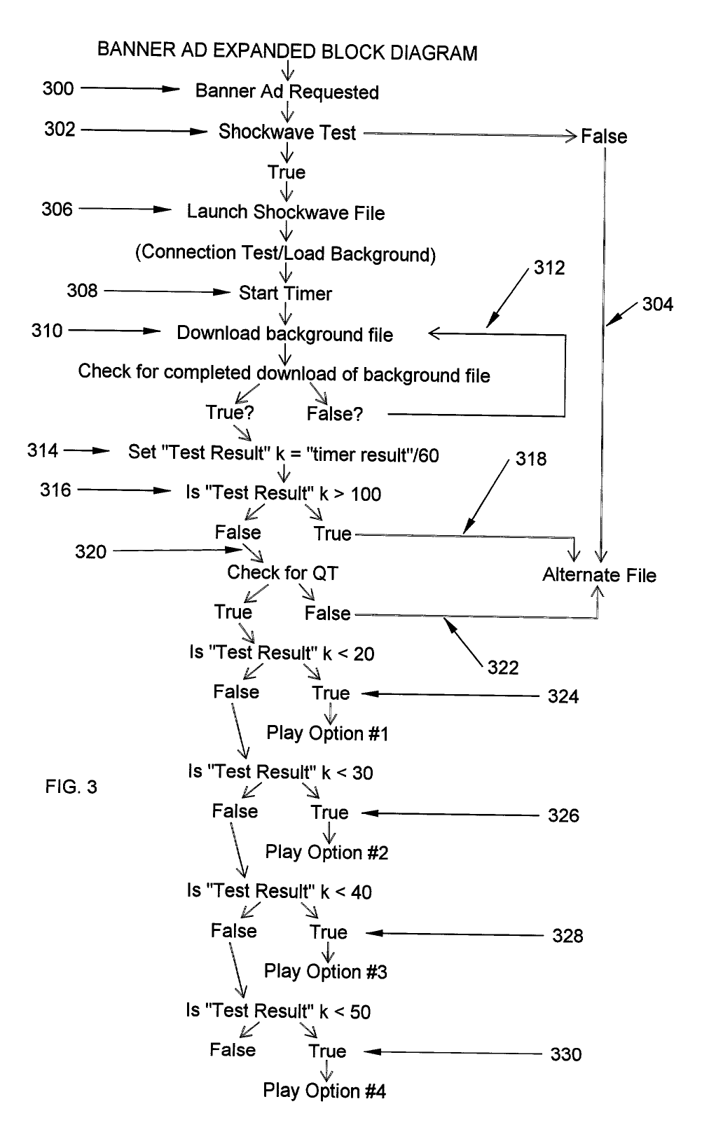

FIGS. 2 and 3 illustrate two applications of real time, on line, testing and transmission of a motion picture file to an end user system, in accordance with the present invention. FIG. 2 is a flow chart illustrating the manner in which a message file is transmitted to an end user system, according to the principles of the present invention. FIG. 3 is a flow chart illustrating the manner in which a banner file is transmitted to an end user system, according to the principles of the present invention.

In the system and method according FIG. 2, the process begins with the end user system being sent a message file (see Step 200). This is a 2 k-3 k file with some initial working about the product and an explanation on how to use it. If the end user's computer is set to automatically download embedded HTML files the program immediately begins to load when the end user opens the message file. If not, the instructions include a click-able link to an outside site for the end user to use.

Once the program is initiated, the software checks the user system for its ability to receive a Shockwave file (step 202). A Shockwave file (or DCR file) is a file that sits in the transmitter's warehouse in format that is created by a program called Macromedia Director. It is an executable file that when run plays back a set of instructions that allow images and files to be downloaded to the end user's computer. This executable file is created by the Macromedia Director program, which is made by Macromedia and is used as an authoring program. Within this program, an application can be programmed and tested for line speed, player capability, and other end user functionality. Once programming is complete Macromedia Director creates the Shockwave file for end user download.

If the end user system cannot receive a Shockwave file, the file is sent in an alternative (e.g. HTML) format, as described further in connection with the system of FIG. 3. If the end user system is capable of receiving a Shockwave file, a Shockwave movie begins to download from a virtual warehouse site (step 204). The Shockwave movie begins to play on the end user system when download is completed. It starts, in real time and on line, by initiating a timer and then downloading a background image and displaying it on the end user's computer in a manner similar to that described below in connection with FIG. 3. The program then tests the download speed of the user's computer by comparing the file size of the background file and the amount of time elapsed on the timer (step 206). From this result the program determines the current line speed of the end user system (step 208).

Once the current on line speed of the end user is determined, the program determines what is an appropriate file for the end user to view (step 210). If the file speed is less than a predetermined speed (e.g. in this example less than 3 k a second) the end user is downloaded an image file in the alternative (e.g. HTML) format (step 212) with the option of downloading the movie file if the user decides. The program calculates the amount of time it should take the user to download the file and displays it for the user to help in the decision making.

If the initial tested download speed is at a certain level above the predetermined minimum (e.g. in this example if it falls between 3 k-8 k a second) the program downloads a Flash animation to the end user (step 214) which plays and then gives the end user the opportunity to download the larger movie file as before.

Moreover, if the initial tested download speed is even faster (e.g. if it is greater than 8 k a second) the program initiates a test for the Quicktime movie player on the end user's computer (step 216). If it finds the appropriate player the program begins to download the movie to the end user displaying the amount downloaded as a percentage on the end user's screen (step 218). Once the movie has completely downloaded it begins playing and at the end it gives the end user a chance to play the movie over (step 220). If the program cannot find a Quicktime movie player it then searches the end user's system for a Windows Media Player (step 222). If it finds this it begins to download an AVI file to the end user's computer again showing the percentage player and such as above (step 224). If the program is unable to find either movie player it defaults back to the Flash file and allows the end user to watch it (step 226).

In an alternative configuration, the system begins by looking for a compatible movie player on the end users computer. It starts by searching for Quicktime Movie Player. If it finds an occurrence of this player on the end user machine it then goes and tests for download speed capabilities and plays the appropriate sized movie. If an occurrence of Quicktime Movie Player is not found the system then searches for an occurrence of Windows Media Player. If an occurrence of this is found then the system test for download speed and plays the appropriate movie. If the system does not find an occurrence of Windows Media Player it then searches the end user computer for an occurrence of a Flash Player. If it finds an occurrence then it downloads a Flash file to the end user. If an occurrence of a Flash Player is not found the end user is downloaded a standard HTML text message.

Another system and method according to the present invention is illustrated in FIG. 3. The process starts with an outside request from a site for the banner ad (step 300). The file request is sent an initial test for the Shockwave plug-in (step 302). If this test comes back FALSE then the end user system is sent a regular HTML style banner ad and the process is completed (step 304). If the request comes back TRUE then the end user system is sent a Shockwave movie with instructions to launch it (step 306).

Once the movie is launched it immediately starts a reference timer (step 308) and then proceeds to download from an external site the background image(s) (step 310). The program is then sent into a loop checking on the download progress until the times have been completely downloaded (step 312). Once this is complete a variable is set to determine the amount of time it has taken to download the file (step 314). This result is then saved and used to determine if it met the minimum standards that are required (step 316). If it did not then the program is complete and the HTML style banner is used (step 318). If it did make the required time standards then a check is made for the Quicktime movie player on the end user's computer (step 320). If this comes back FALSE the program is completed, and the HTML style banner is used (step 322). If this comer back TRUE the program then determines for what file size the user's connection speed is optimized (steps 324, 326, 328, 330). By basically starting at the best available resolution and continuing downward the test result parameters are eventually met and the appropriate file is sent to the site. Once completely downloaded the file plays and then gives the end user an option to loop back to the beginning point of the movie and play it again.

In both of the foregoing examples, the image files that are transmitted to an end user system are in a compressed format. The compressed files are created in the manner described below.

Specifically, in creating a compressed motion picture file, footage is acquired (e.g. with a Sony BetaSP camera). The footage is digitized using an AVID Media Composer 1000 system playing back from a Sony BetaSP 2800 playback deck. The video is edited and condensed down to the desired length using the AVID editing system. Music and effects are added as needed and the entire sequence is then saved for export to Quicktime format. Using the AVID system, the sequence is exported to Quicktime using the AVID CODEC (compressor/decompressor) provided with the AVID system.

Once the Quicktime file is created is sent to a Power Macintosh PC where the file is inserted into the Media Cleaner Pro Program. The Media Cleaner Pro program is then manually manipulated to condense and compact the existing Quicktime file into a second Quicktime file. This process involves the testing of different CODEC's and file data rates to determine the best results for each individual file. Once a combination is decided upon, the file is tested on various computers to insure proper playback when inserted on a storage card. After testing the file is either deemed passing or failing. If the results come back as failing the Media Cleaner Pro is used again to manipulate data rate once again and perform the necessary tests until the results are at a passing level. When the file is listed as passing it is imported into the Macromedia Director Program where programming of the storage card is done. Macromedia Director then creates a “projector” for final distribution to a master CD-ROM. This projector is then tested for performance on various computers once again. Upon receiving the final passing result the entire projector is “burned” or written to a CD-ROM Master where it under goes one last testing on various computers to insure proper playback. Upon final approval the master is then sent for duplication and die cutting of the shape.

Thus, according to the present invention, a new and useful system and method has been provided for testing the downloading speed and other characteristics of an end user's system, and then sending an image file (e.g. a motion picture file) in a format and size that is most compatible with the characteristics of the end user's system. Of course, it will be clear to those in the art that while particular downloading speed characteristics are described in the examples, those downloading speeds, as well as other end user system characteristics, could be varied in accordance with the principles of the present invention. Moreover, while the system has been described in a configuration in which the Shockwave program effectively tests and controls the various functions of the entire system, the system could also be configured to be controlled in a JAVA based program, with the Shockwave program functioning under the control of the JAVA program.

The manufactures and/or distributors of the various programs described above are set forth in the following List of Software Used.

### Software Used

AVID Media Composer (editing system)

AVID Technology

Avid Technology Park

One Park West

Tewksbury, Mass. 01876

www.avid.com

Quicktime

Apple

1 Infinite Loop

Cupertino, Calif. 95014

www.apple.com

Media Cleaner Pro

Terran Interactive

15951 Los Gatos Blvd, Suite 1

Los Gatos, Calif. 95032

www.terran.com

Macromedia Director

Macromedia, Inc.

600 Townsend Street

San Francisco, Calif. 94103

www.macromedia.com

Macromedia Flash

See above

Windows Media Player

Microsoft

www.microsoft.com

1. A system for transmitting an image file to an end user system, comprising compression software for compressing the image file into different file formats, and test software configured to test the downloading speed capabilities of the end user system on line and in real time as the system prepares to transmit the compressed file, said system configured to send the compressed file in one file format if the downloading speed of the end user system is slower than a predetermined minimum level and to send the compressed file in another file format if the downloading speed of the end user system is faster than the predetermined minimum level.

2. A system as defined in claim 1, wherein said system has an default file format if the downloading speed of the end user system is faster than the predetermined level, and said system is configured to further test the end user system for one or more predetermined file player modules if the downloading speed of the end user system is faster than the predetermined level, said system being further configured to transmit the compressed file in the default file format if the system determines that the system downloading speed is faster than the predetermined speed but the end user system does not have any of the predetermined file player modules.

3. A system as defined in claim 1, wherein said test software comprises a test file having a known size, and a software module that starts a timer and downloads the test file on the user system, said software module being configured to determine the end user system speed required to download the test file to determine the downloading speed of the end user system.

4. A system for transmitting an image file to an end user system, comprising a test device configured to test the downloading speed of the end user system on line and in real time as the system prepares to transmit the image file; and said system configured to send the image file in one format if the downloading speed of the end user system is at or slower than a predetermined speed and in another format if the downloading speed of the end user system is faster than the predetermined speed.

5. A system for transmitting an image file on line to an end user system, comprising a test device configured to test the downloading speed of the end user system on line and in real time as the system prepares to transmit the image file; and said system configured to send the image file in one size file if the downloading speed of the end user system is at or slower than a predetermined speed and in another size file if the downloading speed of the end user system is faster than the predetermined speed.

6. A method for transmitting an image file on line to an end user system, comprising the steps of testing the end user system in real time and on line to determine if the end user system can play an image file in a predetermined file format, further testing the downloading speed of the end user system and transmitting the image file in the predetermined format if the on line test determines the end user system has a minimum predetermined downloading speed and can play the image file in the predetermined format, and transmitting the image file in an alternative format if the on line test determines the user system cannot play the image file in the predetermined file format.

7. A method for transmitting an image file on line to an end user system, comprising the steps of testing the end user system in real time and on line to determine if the end user system can play an image file in a predetermined file format, if the on line test determines the end user system can play the image file in the predetermined format, further testing the end user system on line and in real time to determine the downloading speed of the end user system and also if the end user system has one or more selected types of players for the image file, and transmitting the image file in a file format which is compatible with a selected player if the further testing determines the end user system has a minimum downloading speed and the selected player.

8. A method for transmitting an image file on line to an end user system, comprising the steps of testing the end user system in real time and on line to determine if the end user system can play an image file in a predetermined file format, if the on line test determines the end user system can play the image file in the predetermined format further testing the end user system on line and in real time to determine the downloading speed of the end user system and also if the end user system has one or more selected types of players for the image file, and transmitting the image file in a file format and in a file size which is compatible with a selected player if the further testing determines the end user system has a minimum downloading speed and the selected player.

9. A method as defined in any of claims 6 through 8, wherein said image file comprises a motion picture file.

10. A system as defined in any of claims 1 through 5, wherein said image file comprises a motion picture file.
